(19) United States
(12) Patent Application Publication
(10) Pub. No.: US 2014/0052767 A1
(43) Pub. Date: Feb. 20, 2014

(54) APPARATUS AND ARCHITECTURE FOR GENERAL POWERING COMPUTATION

(71) Applicants: Javier Diaz Brugueira, Santiago (ES); Alvaro Vazquez Alvarez, Santiago (ES)

(72) Inventors: Javier Diaz Brugueira, Santiago (ES); Alvaro Vazquez Alvarez, Santiago (ES)

(73) Assignee: UNIVERSIDADE DE SANTIAGO DE COMPOSTELA, Santiago De Compostela (ES)

(21) Appl. No.: 13/964,057

(22) Filed: Aug. 10, 2013

Related U.S. Application Data
(60) Provisional application No. 61/683,662, filed on Aug. 15, 2012.

(51) Int. Cl. G06F 7/483

(52) U.S. Cl. CPC G06F 7/483
USPC 708/500; 708/495

(57) ABSTRACT

An apparatus for general powering computation is disclosed. The apparatus is capable of computing a powering function of a floating-point number with an unrestricted exponent. The unrestricted exponent can be a fixed-point or a floating-point exponent. Additionally, the unrestricted exponent can be an inverse of a number in order to enable for q-th root computation using the same hardware processor and architecture.

### CROSS-REFERENCE TO RELATED APPLICATIONS

This application claims the benefit of U.S. Provisional Application No. 61/683,662 filed on 2012-08-15 by the present inventors, which is incorporated herein by reference.

### TECHNICAL FIELD

Disclosed embodiments relate to computational apparatuses and methods. Specifically, disclosed embodiments are related to apparatuses, architectures, and methods for general powering computation.

### BACKGROUND

The design of functional units for the computation of powering and q-th roots (X^{Z}, Z=p or Z=1/q, where p, q are integers) has been a challenging task for years. The powering and q-th root extraction is used frequently in required operations in the fields of computer graphics, digital signal processing, and scientific computation. This includes the computation of square root (X^{1/2}), inverse square root (X^{-1/2}), cubic root (X^{1/3}), inverse cubic root (X^{-1/3}), squaring (X²), inverse squaring (X⁻²), reciprocal (X⁻¹), exponential (e^{y} or 2^{y}), and some other less frequent but also important functions.

There are a number of architectures for the computation of the exponential and logarithm; however accurately computing the floating-point powering function and the root extraction is difficult. The prohibitive hardware requirements of a table-based implementation and the high intrinsic complexity of digit-recurrence based algorithms have lead only to partial solutions, such as powering or root extraction for a constant exponent or for very low precision. The traditional approximation to powering and q-th root extraction has been the development of functional units for the computation of a given power or root. Accordingly, there is a number of algorithms and implementations for the most frequent exponents, reciprocal, square root and the inverse square root calculation, including linear convergence digit-recurrence algorithms and quadratic convergence multiplicative-based methods, such as Newton-Raphson and Goldschmidt algorithms. There are also several approaches for the calculation of other exponents derived from the application of general methods for function evaluation to the case of powering.

In general, in the calculation of a powering or a q-th root with very low precision it is possible to employ direct table look-up, but its high memory requirements make it an inefficient method for single- or double-precision floating-point formats. Polynomial and rational approximations are another way of implementing the powering and q-th root extraction. However, one of the most efficient methods in floating-point representation is table-driven algorithms, which are halfway between direct table look-up and polynomial and rational approximations. The use of a polynomial approximation allows the table size to be reduced and the table look-up allows us to reduce the degree of the polynomial.

There are first and second order polynomial approximation based on a Taylor expansion for the calculation of a limited number of powers and roots, square root, reciprocal square root, fourth root, etc., such as those described in Powering by a Table Look-Up and a Multiplication with Operand Modification by N. Takagi, IEEE Transactions on Computers, vol. 47, no. 11, pp. 1216-1222, November 1998; Faithful Powering Computation Using Table Lookup and Fused Accumulation Tree by J. A. Piñeiro, J. D. Bruguera and J. M. Muller, Proceedings 15th IEEE Symposium on Computer Arithmetic, pp. 40-47, June 2001; and High-performance architectures for elementary function generation by J. Cao, B. W. Y. Wei and J. Cheng, Proceedings 15th IEEE Symposium on Computer Arithmetic, pp. 136-144, June 2001, but those implementations require to replicate the table to store the coefficients and cannot be considere as general q-th root caculations units.

A digit-recurrence method for the q-th root extraction has been presented in An Digit-by-Digit Algorithm for m-th Root Extraction by P. Montuschi, J. D. Bruguera, L. Ciminiera and J. A. Piñeiro, IEEE Transactions on Computers, vol. 56, no. 12, pp. 1696-1706, December 2007, and particularized to the radix 2 cube root computation in A Radix-2 Digit-by-Digit Architecture for Cube Root by A. Piñeiro, J. D. Bruguera, F. Lamberti, P. Montuschi IEEE Transactions on Computers, vol. 57, no. 4, pp. 562-566, April 2008. The complexity of the resulting architecture depends on q, such as the larger q the larger the complexity. Consequently, the architecture for the computation of large q-th roots is difficult to implement. There are also some other specific digit-recurrence implementations for both square and cube root computations presented in Digit-by-Digit Methods for Computing Certain Functions by M. D. Ercegovac, 41st Asilomar Conference on Signals, Systems and Computers, pp. 338-342, November 2007; and A Digit-Recurrence Algorithm for Cube Rooting by N. Takagi, IEICE Transactions on Fundamentals of Electronics, Communications and Computer Sciences, vol. E84-A, no. 5, pp. 1309-1314, May 2001.

It has to be pointed out that all the methods outlined above for the powering computation and q-th root extraction are targeted for a given exponent. That means that the resulting architecture cannot be used for the calculation of a power or root different to that it has been designed for. To adapt the architecture to a different power or root requires to change the lookup tables in the case of table-driven polynomial approximations, or to design a completely new architecture, in the case of the digit-recurrence method. The table-driven polynomial approximations can be adapted to compute more than just one power or root, but this needs the replication of the lookup tables. In any case, the methods above cannot be considered as general methods for the calculation of any power or q-th root.

The only architecture in the literature for the q-th root extraction for any q is described in Algorithm and Architecture for Logarithm, Exponential and Powering Computation by J. A. Piñeiro, M. D. Ercegovac and J. D. Bruguera, IEEE Transactions on Computers, vol. 53, no. 9, pp. 1085-1096, September 2004, and was designed for the computation of the powering function X^{p}, with p any integer, based on a logarithm-multiplication-exponential chain implementation speeded-up by using redundancy and online arithmetic, and extended to the computation of X^{1/q}. However, the extended architecture for the q-th root extraction is hard to implement, because in addition to the operations in the chain, it includes an integer division and requires the calculation of the remainder of the division.

### SUMMARY

Disclosed embodiments include an apparatus for general powering computation that comprises (a) a plurality of memory elements; and (b) a hardware processor configured to compute the powering function X^{Z} of a floating-point number X, wherein Z is an unrestricted exponent. The unrestricted exponent can be a fixed-point or a floating-point exponent. Additionally, the unrestricted exponent can be an inverse of a number to enable for q-th root computation as part of the same hardware processor. According to one embodiment, the hardware processor comprises a multiplexing unit, a reciprocal unit, a logarithm unit, an exponential unit, a multiplication unit, a shifter unit, or combinations thereof. The reciprocal unit, logarithm unit, and multiplication unit are configured to perform computations contemporaneously, and the exponential unit is configured to perform computations in an on-line basis. In a particular embodiment, and without limitation, the reciprocal, logarithm, and multiplication units are configured to perform computations in a most-significant-digit first basis. Disclosed embodiment also include methods for performing general powering computation.

### BRIEF DESCRIPTION OF THE DRAWINGS

Disclosed embodiments are illustrated by way of example, and not by way of limitation, in the figures of the accompanying drawings.

FIG. 1 is a sequence of operations to compute the powering function X^{Z} with a fixed-point exponent according to one embodiment.

FIG. 2 is a block diagram of a processor for performing the powering calculation, X^{Z} with a fixed-point exponent Z according to one embodiment.

FIG. 3 is a sequence of operations to compute the X^{Y} and X^{1/Y}, being X and Y single-precision floating-point numbers according to one embodiment.

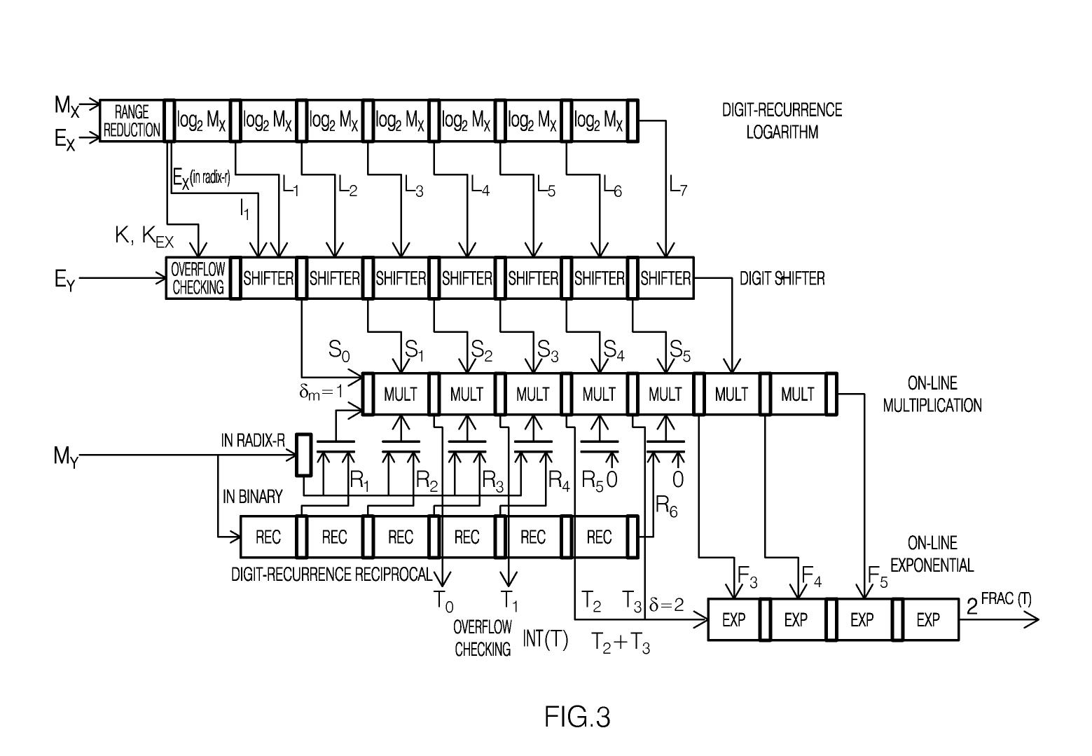

FIG. 4 is a method for shifting the logarithm according to one embodiment.

FIG. 5 is a block diagram of a processor for performing the powering calculation X^{Z} with a fixed-point or floating-point exponent Z according to one embodiment.

FIG. 6 is an example of parameters for powering computation and root extraction with fixed-point exponent, number of bits of the intermediate results and latencies, using a radix r=128 and simple and double precision results.

FIG. 7 is an example of parameters for powering computation and root extraction with floating-point exponent, number of bits of the intermediate results and latencies, using a radix r=128 and simple and double precision results.

### DETAILED DESCRIPTION

Microprocessors have a general structure to deal with common operations, such as memory access, software instruction execution, peripheral control, and arithmetic calculations. The complexity of some operations such as the square root, cubic root, and inverse does not allow to incorporate an specific hardware to compute these operations within the microprocessor. Consequently, current microprocessors incorporate floating point units (FPUs) to carry out complex operations such as square root or division of floating points numbers. However, the functionality of FPUs is limited as they cannot implement a large number of operations and complex operations must be carried out using a software solution. The software solution degrades the overall performance of the system as it slows down the computations. Disclosed embodiments include an apparatus that implements qth-roots and general powering computations.

Disclosed embodiments, and without limitation, include methods and apparatuses for the powering computation and the root extraction X^{Y}, X and Y being floating-point numbers, X=(−1)^{s}^{ₓ}×Mₓ×2^{E}^{ₓ} and Y=(−1)^{s}^{_{z}}×M_{y}×2^{E}^{_{y}}, Mₓ and M_{y} being the n-bit significands (i.e., the n bits of the significand include the hidden bit, and least-significant bit (LSB) has a weight 2⁻⁽ⁿ⁻¹⁾) and Eₓ and E_{y} the n_{Ex}-bit signed exponents, or Y being a n_{y}+1-bit fixed-point exponent of the form

$$Y = \{ \begin{matrix}y & in powering computation \\ 1 / y & in root extraction\end{matrix}$$

being y a signed integer operand of n_{y}+1 bits, with |y|≧2 for root extraction.

### A. Apparatus for a Fixed-Point Exponent

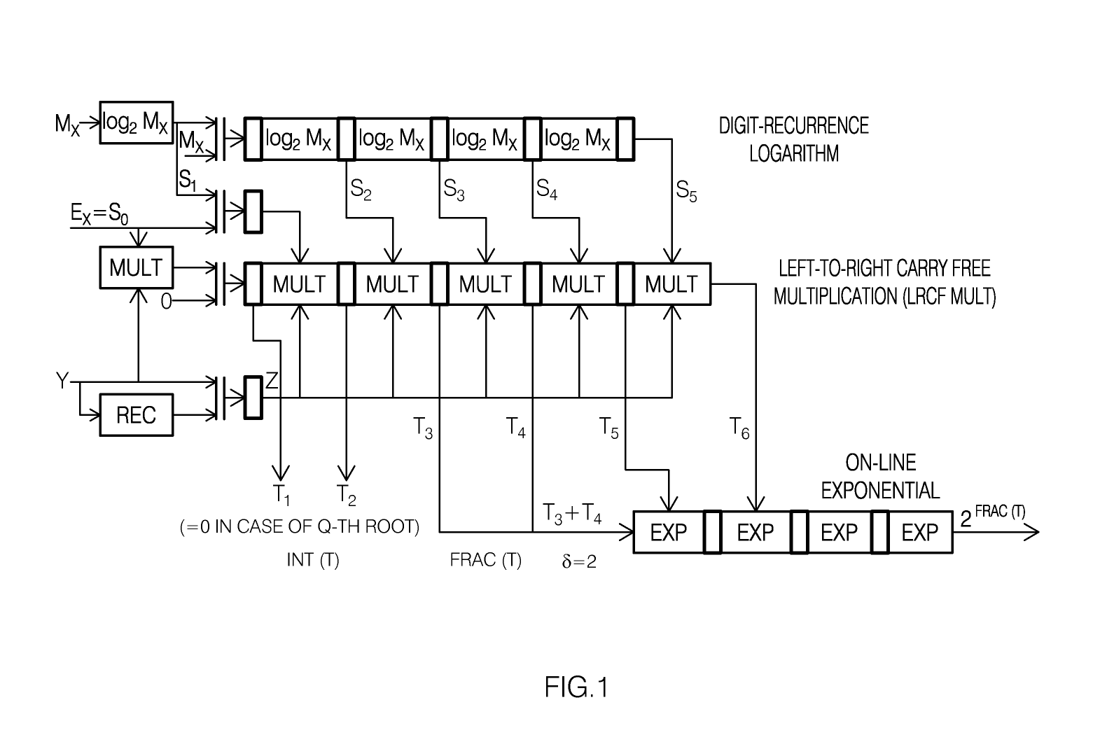

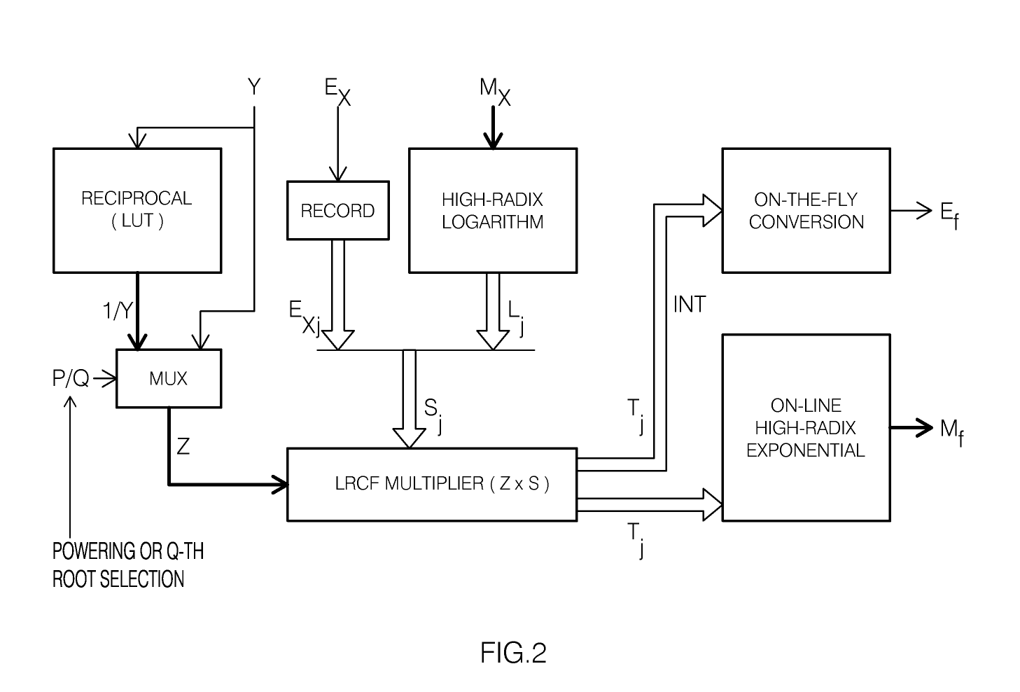

According to a particular embodiment, and without limitation, the apparatus for computing Z-th powering or Z-th root of a number X comprises: (a) a plurality of memory elements such as registers, for storing a number X whose Z-the powering or Z-th root is to be computed, a fixed-point number Z that indicates the powering or root exponent, the number of significant bits of the number X and of the resulting computation, the operation being performed, Z-th powering or Z-th root and the former exponent of Z; (b) a reciprocal unit for computing the reciprocal of Z resulting in a number A; (c) a logarithm unit for computing the logarithm base 2 of the number X resulting in a number B; (d) a multiplication unit for computing the product of said numbers A and B resulting in a number C; (e) a exponential unit for computing the exponential of said number C. In particular embodiments, the reciprocal unit operates in parallel with the logarithm unit, the logarithm unit and the multiplication unit overlap during computation, the exponential unit and the multiplication unit overlap during computation, the exponential unit computes the exponential in an on-line basis, the logarithm unit computes the logarithm in a most-significant digit first basis, and/or the multiplication unit computes the product in a most-significant-digit first basis. According to one particular embodiment, as shown in FIG. 2, the architecture of the apparatus comprises a reciprocal look-up table unit, a high radix logarithm unit, a LRCF multiplier, a conversion unit, and a high radix exponential unit. In an alternative embodiment, the architecture of the apparatus comprises a word-length barrel shifter unit, a high-radix reciprocal unit, a high-radix logarithm unit, a high-radix multiplier, a conversion unit, and a high-radix exponential unit. FIG. 2 shows the block diagram of the apparatus for computing X^{Z} for a fixed-point exponent Z according to one embodiment. Single thick lines represent long-word operands (around n bits), single thin lines represent short-word operands (around b; r=2^{b} radix or n_{Ex} bits), and double lines represent redundant signed radix-r digits in a borrow-save format (or signed-digit radix 2). To enable for faster execution of iterations in these units, all variables are represented in a redundant borrow-save representation. This results in an easier conversion of signed radix-r digits. Moreover, a borrow-save adder can be implemented as a carry-save adder with some inverted inputs and outputs. FIG. 1 shows sequence of operations to compute the powering function X^{Z} with a fixed-point exponent according to one embodiment. For the purposes of illustration, the apparatus is shown for the powering and root computation with a fixed-point exponent and a generic radix r=2^{b}.

### B. Method for a Fixed-Point Exponent

According to one embodiment, the computing of Z-th powering or Z-th roots in a hardware processor comprises: (a) setting a first memory element of the processor to a number X, wherein X is a number whose Z-the powering or Z-th root is to be computed; (b) setting a second memory element of the processor to a number Z, wherein Z is a fixed-point number that indicates the powering or root exponent; (c) setting a third memory elements of the processor to the number of significant bits of the number X and of the resulting computation; (d) setting a fourth memory element of the processor to the operation being performed, Z-th powering or Z-th root; (e) setting a fifth memory element to the former exponent of Z; (f) computing the reciprocal of the number Z resulting in a number A; (g) computing the logarithm base 2 base 2 of the number X resulting in a number B; (h) computing the product of the number A and B resulting in a number C; (i) separating the integer and fractional parts of the number C; and (j) computing the exponential of the number C. In particular embodiments, the computing of the logarithm and the product are overlapped, the computing of the product and the computing of the exponential are overlapped, the number X is represented in a simple or double precision binary floating-point form according the standard IEEE-754, the number q is represented in a binary fixed-point form, and the processor in chosen from the group consisting of an integrated circuit, a FPGA device, a microprocessor, a microcontroller, and a general purpose computer system.

According to a particular embodiment, and without limitation, the method is derived as follows

X^{Z}=2^{log}^{₂}^{(X}^{^{Z}}₎=2^{Z×log}^{₂}^{X} (1)

considering that X is a floating-point operand this equation can be rewritten as

$$\begin{matrix}{X}^{Z} = {2}^{Z \times {log}_{2} ( {M}_{x} \times {2}^{{E}_{x}} )} \\ = {2}^{Z \times S}\end{matrix} \qquad ( 2 )$$

where S=Eₓ+log₂Mₓ is the concatenation of the digits of Eₓ (integer value) and log₂(Mₓ)ε[0,1).

According to equation (2), X^{Z} can be calculated as a sequence of operations: (1) logarithm of the significand Mₓ(log₂Mₓε[0, 1)), (2) addition of Eₓ and log₂Mₓ (concatenation of binary strings), (3) multiplication by Z, and (4) exponential of the result of the multiplication. For an efficient implementation, the operations involved must be overlapped. This requires a left-to-right most-significant digit first (MSDF) mode of operation and the use of a redundant representation. A radix-r signed-digit representation with a maximally redundant digit set {−(r−1), . . . , 0, . . . (r−1)} is employed.

A potential limitation of the algorithm above for certain applications is the range of the exponential function 2^{Z×S}. Digit-recurrence exponential algorithms require the argument to be in the interval (−1, 1), while Z×S must be out of the range. To extend the range of convergence and guarantee the convergence of the algorithm, the integer and fractional parts of Z×S must be extracted serially and equation (2) must be rewritten,

X^{Z}−2^{Z×S}−2^{int(Z×S)}×2^{frac(Z×S)} (3)

being int(Z×S) and frac(Z×S) the integer and fractional parts of Z×S, respectively. Therefore, according to equation (3) and considering F=X^{Z}=M_{f}×2^{E}^{_{f}}, the significand M_{f} and the exponent E_{f} of X^{Z} are

M_{f}=2^{frac(Z×S)} (4)

E_{f}=int(Z×S) (5)

The argument of the exponential 2^{frac(Z×S)} is now in (−1, 1). The number of integer bits of Z×S is larger for X^{y} than for X^{1/y}. In case of root extraction, the number of integer bits depends only on Eₓ; but in powering depends moreover on y. According to one embodiment, the sequence of operations is as follows:
1. Evaluation of Z=(−1)^{s}_{^{y}}×1/|y| (only if root is being extracted, module rec in FIG. 1, being s_{y} the sign of y. For practical cases, a low precision value for |y| is enough and a lookup table (LUT) is preferable for the computation of 1/|y|. Therefore, a LUT of n_{y} inputs and n_{z} outputs (n_{z} fractional bits, non-redundant binary representation), is used.
2. Evaluation of the logarithm L=log₂Mₓε[0, 1) to a precision of nₗ bits using a high-radix digit-recurrence algorithm. The logarithm is in a signed-digit radix r representation. Note that, as the logarithm in the powering function needs one more stage than in root extraction, the first stage is skipped in case of root extraction.
3. Multiplication T=Z×S. Operand S=Eₓ+L=Σ_{i=-┌(n}_{_{Ex}}_{-1)/b┐+1}Sᵢr⁻¹ is obtained by concatenating the digits of Eₓ (integer digits), recoded to a signed-digit radix r representation, and L (fractional digits). The multiplication is evaluated using a LRCF (left-to-right carry-free) multiplier.
4. Serial extraction of the integer int(T) and fractional frac(T) parts of T, and on-the-fly conversion of int(T) to a non-redundant representation. Note that the number of integer digits depends on the operation and one cycle is required to obtain each one. Hence, the number of integer digits is ┌(n_{Ex}−1+n_{y})/b ┐ for powering and ┌(n_{Ex}−1)/b┐ for root extraction.
5. On-line high-radix exponential 2^{frac(T)}ε(0.5, 2) with frac(T)ε(−1, 1), precision of nₑ bits, and on-line delay δ=2. The redundant result is normalized and rounded to n bits using an on-the-fly rounding unit.
   The number of stages of the logarithm and the multiplication are different for powering and root extraction; in fact, from the error analysis it is obtained that, in this case, the calculation of the powering function needs one more logarithm and multiplication stage than the root extraction. In order to accommodate these two different datapaths, with different number of stages for logarithm and multiplication, and different number of integer digits, several multiplexers has been placed in the first stage of FIG. 1.

The number of digits in the integer part is ┌(n_{Ex}−1)/b┐+1 for powering and ┌(n_{Ex}−1)/b┐ for root extraction. Since root extraction needs to compute Z=1/y, the number of cycles required to obtain the integer part of both algorithms is the same, ┌(n_{Ex}−1)/b┐+1. Consequently, the total latency is given by

N=(┌(n_{Ex}−1)/b┐+1)+(δ+1)+Nₑ (6)

where Nₑ=┌nₑ/b┐ is the latency of the exponential 2^{frac(T)}.

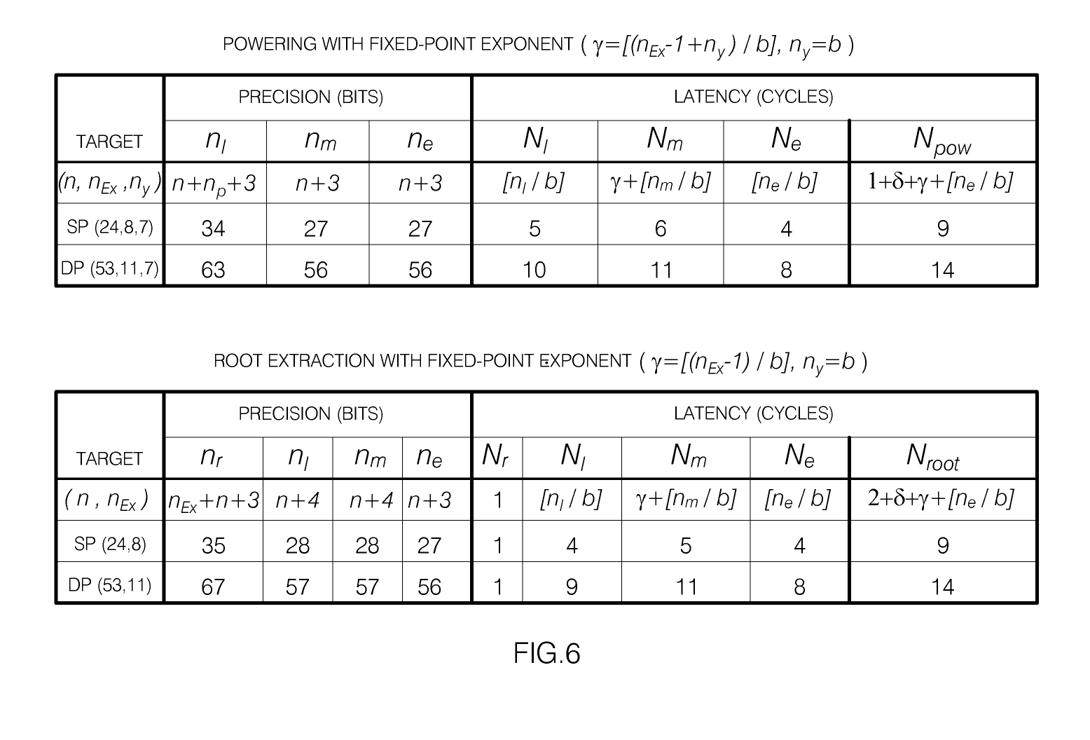

To provide faithfully rounded powering and root extraction, the rounded result must be within 1 ulp of the exact result. Assuming rounding to the nearest even, The required precision and minimum latency values for each intermediate operation and the latency for the complete operation are shown in the Table of FIG. 6. These values are provided for single (SP) and double (DP) precision with r−128.

### C. Apparatus for Fixed-Point and Floating-Point Exponents

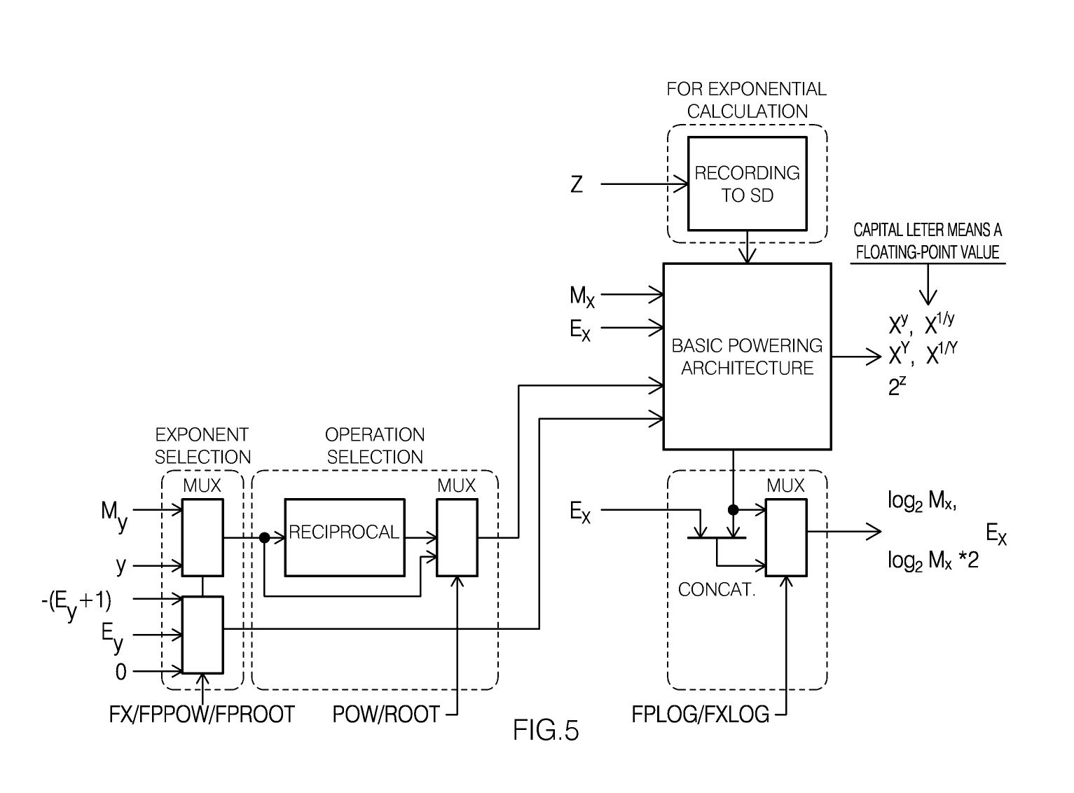

According to a particular embodiment, and without limitation, the apparatus for computing Z-th powering or Z-th root of a number X comprises: (a) a plurality of memory elements such as registers for storing number X whose Z-the powering or Z-th root is to be computed, a floating-point or fixed-point number Z that indicates the powering or root exponent, the number of significant bits of the number X and of the resulting computation, the operation being performed, Z-th powering or Z-th root and the former exponent of Z; (b) a reciprocal unit for computing the reciprocal of Z resulting in a number A; (c) a logarithm unit for computing the logarithm base 2 of the number X resulting in a number B; (d) a shifter unit for shifting the number B in case of Z being a floating-point number, resulting in a number B′ (e) a multiplication unit for computing the product of said numbers A and B or B′ resulting in a number C; and (f) a exponential unit for computing the exponential of said number C. In particular embodiments, the reciprocal unit operates in parallel with the logarithm unit, the logarithm unit and the multiplication unit overlap during computation, the exponential unit and the multiplication unit overlap during computation, the exponential unit computes the exponential in an on-line basis, the logarithm computes the logarithm in a most-significant digit first basis, the shifting is computed in a most-significant-digit first basis, and/or the multiplication unit computes the product in a most-significant-digit first basis. According to one particular embodiment, the architecture of the apparatus comprises an exponent selection unit, an operation selection unit, a reciprocal look-up table unit, a high radix logarithm unit, a LRCF multiplier, a conversion unit, and a high radix exponential unit. In an alternative embodiment, the architecture of the apparatus comprises a word-length barrel shifter unit, a high-radix reciprocal unit, a high-radix logarithm unit, a high-radix multiplier, a conversion unit, and a high-radix exponential unit. FIG. 5 shows the block diagram of the apparatus for computing X^{Z} for general exponents.

### D. Method for a Floating-Point Exponent

According to one embodiment the computing of Z-th powering or Z-th roots in a hardware processor comprises: (a) setting a first memory element of the processor to a number X whose Z-th powering or Z-th root is to be computed; (b) setting a second memory element of the processor to a fixed-point number or a floating-point number Z that indicates the powering or root exponent; (c) setting a third memory elements of the processor to the number of significant bits of the number X and of the resulting computation; (d) setting a fourth memory element of the processor to the operation being performed, Z-th powering or Z-th root; (e) setting a fifth memory element to the former exponent of Z; (f) computing the reciprocal of the number Z resulting in a number A; (g) computing the logarithm base 2 base 2 of the number X resulting in a number B; (g) shifting the number B, in case Z is a floating point number resulting in a number B′;(h) computing the product of the number A and B or B′ resulting in a number C; (i) separating the integer and fractional parts of the number C; and (j) computing the exponential of the number C. In particular embodiments, the computing of the logarithm and the product are overlapped, the computing of the product and the computing of the exponential are overlapped, the number X is represented in a simple or double precision binary floating-point form according the standard IEEE-754, the number q is represented in a binary fixed-point form, and/or the processor in chosen from the group consisting of an integrated circuit, a FPGA device, a microprocessor, a microcontroller, and a general purpose computer system.

According to one embodiment the function to be computed is X^{Y} or X^{1/Y}, being X and Y floating-point numbers, X=(−1)^{s}^{ₓ}×Mₓ×2^{E}^{ₓ}, Y=(−1)^{s}^{_{y}}×M_{y}×2^{E}^{_{y}}. Replacing the exponent in equation (1) by a floating-point exponent Y,

$${\vert X \vert}^{Y} = {2}^{{( - 1 )}^{{s}_{y}} \times {M}_{y} \times {log}_{2} \vert X \vert \times {2}^{{E}_{y}}} \qquad ( 7 )$$

### Similarly,

$${\vert X \vert}^{1 / Y} = {2}^{{( - 1 )}^{{s}_{y}} \times ( 1 / {M}_{y} ) \times {log}_{2} \vert X \vert \times {2}^{- {E}_{y}}} \qquad ( 8 )$$

In order to use the same multiplier for both operations, 1/M_{y}ε(0.5, 1] is normalized in [1, 2); then

$${\vert X \vert}^{1 / Y} = {2}^{{( - 1 )}^{{s}_{y}} \times ( 2 / {M}_{y} ) \times {log}_{2} \vert X \vert \times {2}^{- ( {E}_{y} + 1 )}} \qquad ( 9 )$$

As for the fixed-exponent case, to guarantee the convergence of the algorithm, the integer and fractional parts are extracted serially,

|X|^{Z}=M_{f}×2^{E}^{_{f}}=2^{frac(T)}×2^{int(T)} (10)

being Z=Y or Z=1/Y and

$$T = \{ \begin{matrix}{( - 1 )}^{{s}_{y}} \times {M}_{y} \times {log}_{2} \vert X \vert \times {2}^{{E}_{y}} \\ {( - 1 )}^{{s}_{y}} \times ( 2 / {M}_{y} ) \times {log}_{2} \vert X \vert \times {2}^{- ( {E}_{y} + 1 )}\end{matrix}$$

for powering and root extraction, respectively.

The sequence of operations is: (1) reciprocal 1/My for root extraction, (2) evaluation of L=log₂|X|, (3) shifting of the result of the logarithm, L×2^{E}^{_{y}}, (4) multiplication by M_{y} or 1/M_{y} and (5) online exponential. An example of the operation flow of the modified q-th root method for single precision and r−128 is shown in FIG. 6.
1. Evaluation of R=(1/My)×2, only in case of root extraction, by means of a digit recurrence algorithm. The latency is Nᵣ−=┌nᵣ/b┐ for nᵣ bits of accuracy.
2. Computation of L=log₂|X|. The logarithm is computed as L=Eₓ+log₂Mₓ digit-by-digit. To ensure the convergence of the algorithm, arguments Eₓ and Mₓ are slightly modified. To reduce the number of iterations, the number of leading zeros/ones, lₓ, in frac(|Mₓ|) is estimated and the K=└(lₓ−1)/b┘ first iterations are skipped. In contrast, an initial iteration (range reduction) is needed to compute the different variables. In the first cycle, the leading zeros/ones of the fractional and integer parts of L, lₓ and l_{E}_{ₓ} respectively, are obtained by using Leading-Zero detectors (LZD) or Leading-One detectors (LOD), which allows the computation of the number of skipped iterations K and the number of zero digits of the integer part K_{E}_{ₓ}. After that, the logarithm is computed with nₗ=n+n_{E}_{ₓ}+6+b precision bits; this requires Nₗ=┌(n+n_{E}_{ₓ}+6)/b┐+1 iterations.
3. Shifting L by 2^{E}^{_{y}}, S−L×2^{E}^{_{y}}. The shift implementation is described in section other section.
4. On-line left-to-right carry-free multiplication T=M_{y}×S or T=(2/M_{y})×S, depending on the operation being computed, starting in cycle 5 with on-line delay δₘ−1. Note that multiplexers have been included to select the adequate operand for the multiplication, and that in the case of standalone powering implementation the on-line delay δₘ is zero. An additional most significant digit T₀ is computed for detecting overflow (T₀≠0 for overflow).
5. On-line exponential 2^{frac(T)}, starting in cycle 7, because the on-line delay of the exponential is δ=2.
   The latency of the algorithm is 5+γ+δₘ+δ+Nₑ, where δ−2, δₘ−1 (for q-th root and the combined operation), γ−┌(n_{E}_{ₓ}−1)/b1┐ and Nₑ is the latency of the exponential operation.
   Shifts 2^{E}^{_{y}} and 2^{-(E}^{_{y}}⁺¹⁾ impose a limitation to the range of supported Y values (i.e., the shift cannot produce either a result larger than the maximum or lower than the minimum representable floating-point number). According to one embodiment, the practical range of E_{y} for powering is limited to

−(n_{E}_{ₓ}+nₘ)≦E_{y}≦n+n_{E}_{ₓ}−2 (11)

In the case of root extraction, the practical range of E_{y} is limited to

−(n+n_{E}_{ₓ}−1)≦E_{y}≦n_{E}_{ₓ}+nₘ+1 (12)

Consequently, −69≦E_{y}≦61 (−62<E_{y}≦70) and −37≦E_{y}≦29 (−30≦E_{y}≦38) for powering (root extraction) in double-precision and single-precision floating-point representation, respectively.

### D.1 Shifting Method for Unified Architectures

The computation of the powering and the generic root in the unified architecture requires the shifting of L−Eₓ+log₂Mₓ by E_{y}, in case of powering or by −(E_{y}+1), in case of root extraction. In both cases, the shift amount can be positive or negative.

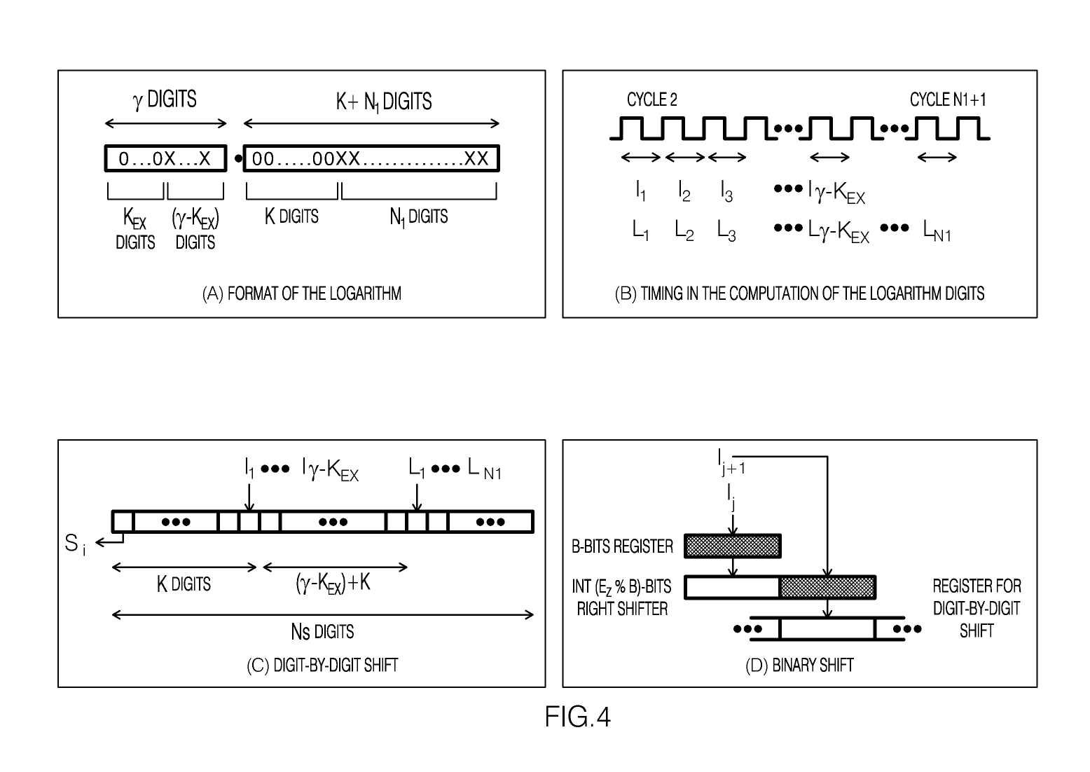

To simplify the presentation of the shifting algorithm, we consider a shift by E_{z}, with E_{z}=E_{y} for powering, and E_{z}=−(E_{y}+1) for root extraction. FIG. 4(A) shows the format of the L=Eₓ+log₂Mₓ. Due to the addition of Eₓ, there is an integer part of γ=┌(n_{Ex}−1)/b┐ radix-r digits, the leading K_{Ex} of which are zeros. If K_{Ex}=γ, then the integer part of L is zero, └L┘=0, which corresponds to the cases (1) Eₓ=0 with Lε[0,1) and (2) Eₓ=−1 with Lε(−1, 0) (i.e., the case Mₓ=1, Eₓ=−1 (X=0.5, L=−1) is filtered out since its evaluation is straightforward). The fractional part has K=└(lₓ−1)/b┘ radix-r leading zeros followed by Nₗ digits. The non-zero radix-r digits of the integer and fractional parts are denoted I₁, . . . , I_{γ-K}_{_{Ex}} and L₁, . . . , L_{N}_{ₗ}, respectively (i.e., the leading zeros of the logarithm are skipped over during its computation; then, these digits are not computed but are represented in the figure for a better comprehension of the shifting).

The digits of the logarithm are computed serially, mostsignificant digit first, and the digits of the integer and fractional parts are obtained in parallel, as shown in FIG. 4(B).

The E_{z}-bit left or right shift is implemented as a right shift: as the leading zeros/ones are not computed, the first non zero digit of the integer and fractional parts of L are obtained simultaneously in cycle 2; this is equivalent to prealign L by placing it K_{E}_{ₓ}+1 (if there is a non-zero integer part) or γ+K+1 (if the integer part is zero) digits to the left, the possible maximum left shift.

The shift is split in two parts: (1) a right shift of (K_{Ex}+1)−└E_{z}/b┘ or (K+γ+1)−└E_{z}/b┘ radix-r digits and (2) a binary right shift of E_{z} % b bits. The digit-by-digit shift is carried out in a displacement register with Nₛ radix b digits (FIG. 4(C)), where Nₛ is roughly equal to Nₗ. All the integer digits Iⱼ enter at the same position of the register but in consecutive cycles. The same for the fractional digits Lⱼ. On the other hand, digit Lⱼ enters (γ−K_{Ex})+K+1 positions to the right of digit Iⱼ. The digits are left shifted out, one digit every cycle.

The position where the Iⱼ digits input the register is determined in terms K_{E}_{ₓ} and E_{y}. Two different cases are identified:
1. The integer part is different from zero, γ≠K_{E}_{ₓ}, which corresponds to |Eₓ|>1. The maximum allowed left shift in L is K_{E}_{ₓ}. Then, digits Iⱼ input the register in position Kₑ_{ₓ}−└E_{z}/b┘+1 and the output of the register has K_{E}_{ₓ}−└E_{y}/b┘ leading zeros/ones digits.
2. The integer part is zero, γ=K_{E}_{ₓ}, which corresponds to Eₓ=0 or Eₓ=−1.The maximum allowed left shift in L is γ+K. Then, the Lᵢ digits are introduced at position γ+K+1−└E_{z}/b┘. Once the digits have been shifted out, there are γ+K−└E_{z}/b┘ leading zeros/ones digits in S.
   Therefore, the shifted logarithm S has Nₛ≦Nₗ+1 digits. The most significant digit S₀ is for detecting overflow (If T₀=S₀×M_{z}≠0 or E_{z}>E_{z max}, then the result overflows), the following γ radix-r digits correspond with the integer part of the shifted logarithm and the remaining K+Nₗ radix-r digits correspond with the fractional part. The binary shift of E_{z} % b bits is carried out by introducing digits Iⱼ and Iⱼ₊₁ together in a b-bits right shifter and discarding the b most significant bits, as shown in FIG. 4(D).

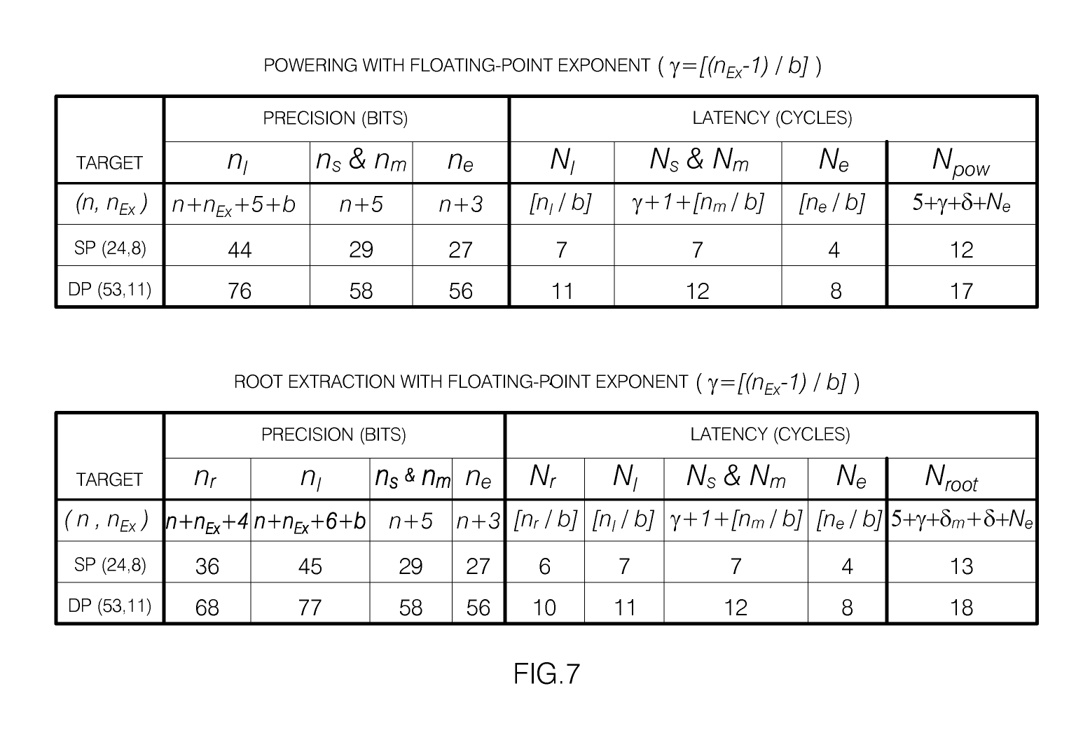

To provide faithfully rounded powering and root extraction, the rounded result must be within 1 ulp of the exact result. Assuming rounding to the nearest even, The required precision and minimum latency values for each intermediate operation and the latency for the complete operation are shown in the Table of FIG. 7. These values are provided for single (SP) and double (DP) precision with r=128.

While particular embodiments have been described, it is understood that, after learning the teachings contained in this disclosure, modifications and generalizations will be apparent to those skilled in the art without departing from the spirit of the disclosed embodiments. It is noted that the disclosed embodiments and examples have been provided merely for the purpose of explanation and are in no way to be construed as limiting. While the methods, systems, apparatuses have been described with reference to various embodiments, it is understood that the words which have been used herein are words of description and illustration, rather than words of limitation. Further, although the system has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

What is claimed is,:

1. An apparatus for general powering computation comprising:
(a) a plurality of memory elements; and
(b) a hardware processor configured for computing a powering function X^{Z} of a floating-point number X, wherein Z is an unrestricted exponent.

2. The apparatus of claim 1, wherein said unrestricted exponent is a fixed-point or a floating-point exponent.

3. The apparatus of claim 2, wherein said unrestricted exponent is an inverse of a number resulting in a q-th root computation using said hardware processor.

4. The apparatus of claim 3, wherein said hardware processor comprises a multiplexing unit, a reciprocal unit, a logarithm unit, an exponential unit, a multiplication unit, a shifter unit, or combinations thereof.

5. The apparatus of claim 4, wherein said reciprocal unit, said logarithm unit, and said multiplication unit are configured for performing computations contemporaneously.

6. The apparatus of claim 5, wherein said exponential unit is configured for performing computations in an on-line basis.

7. The apparatus of claim 6, wherein said reciprocal unit, said logarithm unit, and said multiplication unit are configured for performing computations in a most-significant-digit first basis.

8. The apparatus of claim 7, wherein said hardware processor is chosen from the group consisting of an integrated circuit, a FPGA device, a microprocessor, a microcontroller, a digital signal processor (DSP), and a computer processor.
